(19) United States
(12) Patent Application Publication
(10) Pub. No.: US 2007/0170794 A1
(43) Pub. Date: Jul. 26, 2007

(54) Starter

(75) Inventors: Hisato Inoue, Anjo-shi (JP); Youichi Hasegawa, Kasugai-shi (JP); Kazuaki Murase, Kounan-shi (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 11/642,623

(22) Filed: Dec. 21, 2006

(30) Foreign Application Priority Data
Jan. 26, 2006 (JP) 2006-017872

(51) Int. Cl. H02K 11/00

(52) U.S. Cl. 310/71; 29/596

(57) ABSTRACT

In a starter, a motor terminal is composed of a rigid body made of metal, supported by a grommet, and welded to a connection bar in order to construct a terminal assemble (ass'y). The terminal assemble is constructed into a yoke assemble under the grommet is attached to an opening part of the yoke and the connection bar is welded to an end part of a field coil. An interval between a sealing surface of the grommet and the motor terminal in the yoke assembly, namely before constructing the yoke assembly is smaller than an interval between in the terminal assembly, namely, before constructing the yoke assembly. The grommet has thereby a water proof capability because the grommet is pressed not only the end frame side but also toward the yoke side through the motor terminal when the grommet between the yoke assembly and the end frame is fastened or compressed by through-bolts.

### CROSS-REFERENCE TO RELATED APPLICATIONS

This application is related to and claims priority from Japanese Patent Application No. 2006-17872 filed on Jan. 26, 2006, the contents of which are hereby incorporated by reference.

### BACKGROUND OF THE INVENTION

1. Field of the Invention

The present invention relates to a starter equipped with a motor terminal having a rigid body made of metal supported by a grommet.

2. Description of the Related Art

Japanese patent laid open publication No. JP 2005-120873 has disclosed a conventional starter equipped with a motor terminal having a rigid body which is made of steel, for example. The motor terminal is supported by a grommet made of rubber fastened and supported between a yoke and an end frame. One terminal of the motor terminal, which is extending to the outside of the yoke, is electrically connected to a terminal of a magnetic switch. The other terminal of the motor terminal is extending to the inside of the yoke and fixed and electrically connected to a connector bar by welding. The connector bar is a metal component through which a field coil made of plural field windings arranged at the inside of the yoke is electrically connected to the motor terminal.

Such a motor terminal is supported by the grommet and then fixed to the connector bar. That is, the motor terminal and the grommet (see FIG. 1) are integrated in one body so as to form a terminal assembly (ass'y). The water proof or water tight capability of such a terminal assembly can be achieved by the following manner. First, the connector bar is fixed to one end part of the magnetic coil by welding or another manner, and then an opening part of the yoke is covered with the end frame through the grommet, and the connector bar, the grommet, and the end frame are then tightly fastened to each other. Because the grommet is placed between the yoke and the end frame, this manner can compress the grommet between the yoke and the end frame.

However, because both of the motor terminal and the connector bar are composed of a rigid body made of metal, an approximate position of each of those components is determined when the connector bar is fixed to the one terminal part of the magnetic coil, and each position of the motor terminal and the connector bar does not almost shift even if the end frame covering the opening of the yoke is tightly fastened. As a result, because the grommet is compressed only toward the end frame side from the motor terminal side, but do not compressed toward the yoke side from the motor terminal, such a conventional configuration of the starter cannot obtain a necessary water proof or tight capability between the yoke and the motor terminal. That is, the conventional technique cannot provide adequately tight-fastening between the yoke and the motor terminal through the grommet in view of the necessary water proof capability.

### SUMMARY OF THE INVENTION

It is an object of the present invention to provide an improved starter capable of ensuring a water proof capability between the yoke and the end frame through a grommet.

To achieve the above purpose, the present invention provides a starter having a yoke forming a magnetic circuit, an end frame engaging with an opening part of the yoke, a grommet made of rubber placed and supported between the yoke and the end frame, a motor terminal composed of a rigid body made of metal which is supported by the grommet, a field coil placed in an inner periphery of the yoke, and a connector bar through which the motor terminal is electrically connected to the field coil. In particular, the grommet is assembled in the starter while the grommet is compressed toward the yoke side from the motor terminal.

The grommet is assembled into the yoke while the grommet is pressured toward the yoke side from and by the motor terminal. It is thereby possible to press the grommet towards both directions, not only toward the end frame side, but also toward the yoke from the motor terminal embedded in the grommet. In other words, the grommet is pressed in both directions, toward the yoke side from the motor terminal and also towards the end frame side from the motor terminal. It is thereby possible to ensure the water proof capability of the assembly composed of the yoke, the grommet, and the end frame.

In the starter according to another aspect of the present invention, the motor terminal forms a terminal assembly, which is supported by the grommet and one end part of the motor terminal is fixed to the connector bar. In the starter of the present invention, the terminal assembly is constructed as a part of a yoke assembly in which the connector bar is electrically connected and fixed to an end part of the field coil. In particular, the grommet forming the yoke assembly has a relationship A>B, where A designates an interval between a sealing surface of the grommet at the yoke side and the motor terminal in the terminal assembly before constructing the yoke assembly, and B denotes an interval between the sealing surface of the grommet at the yoke side and the motor terminal after constructing the yoke assembly.

In the configuration of the starter, when the yoke assembly is constructed with the terminal assembly, the interval between the sealing surface of the grommet at the yoke side is decreased. That is, because the grommet is pressed from the motor terminal toward the sealing surface of the grommet at the yoke side after constructing the yoke assembly, the grommet is pressed in both the directions, namely, toward the yoke side from the motor terminal, and toward the end frame side from the motor terminal. That is, the pressure is applied to both directions of the grommet, namely, the entire of the grommet is pressed from the motor terminal, toward the yoke side and also toward the end frame side. It is thereby possible to ensure the water proof capability of the yoke assembly by the grommet.

In the starter according to another aspect of the present invention, the starter further has an insulator capable of electrically insulating the connector bar from the yoke in the yoke assembly. In particular, the grommet is pressed toward the yoke side from the motor terminal while the connector bar is supported by the insulator. In addition, the relationship A>B is satisfied while pressing the sealing surface of the grommet at the yoke side from the motor terminal.

Because the motor terminal electrically connected and fixed to the connector bar is composed of a rigid body, the motor terminal and the connector bar are positioned when the connector bar is supported by the insulator in the yoke assembly. Accordingly, it is thereby possible to tightly fasten the grommet to the yoke side by applying the sealing surface of the grommet toward the yoke side from the motor terminal. In this case, it is not necessary to prepare and use any exclusive tool or jig in order to press the grommet toward the yoke side and thereby to reduce the number of manufacturing steps for manufacturing the starter.

In the starter according to another aspect of the present invention, the field coil is made of a plate shaped conductor having a rigid characteristic wound around field poles fixed to the inner periphery of the yoke, and the grommet is pressed toward the yoke side from the motor terminal while the connector bar is electrically connected and fixed to the end part of the field coil. In addition, the relationship A>B is satisfied so that the sealing surface of the grommet at the yoke side is pressed from the motor terminal.

Because the connector bar and the motor terminal are made of a rigid body and the field coil is made of a plane shaped conductor (, not made of stranded or twisted wire), both of the connector bar and the motor terminal are positioned when the connector bar is fixed to the end part of the field coil. Accordingly, it is possible to assemble the grommet into the yoke assemble while pressing the sealing surface of the grommet at the yoke side toward the yoke side through the motor terminal. In this case, it is not necessary to prepare and use any exclusive tool or jig in order to press the grommet toward the yoke side and thereby to reduce the number of manufacturing steps for manufacturing the starter.

### BRIEF DESCRIPTION OF THE DRAWINGS

A preferred, non-limiting embodiment of the present invention will be described by way of example with reference to the accompanying drawings, in which:

FIG. 1 is a side view of a terminal assembly (ass'y) incorporated in a starter according to an embodiment of the present invention;

FIG. 2 is a sectional view of a yoke assembly incorporated in a starter according to the embodiment of the present invention;

FIG. 3 is a plan view of the yoke assembly shown in FIG. 2 in a side direction thereof;

FIG. 4 is a sectional view showing the yoke assembly, whose opening part is covered with an end frame;

FIG. 5 is a sectional view showing a part of the starter according to the embodiment of the present invention; and

FIG. 6 is a sectional view showing an insulator incorporated in the yoke assembly covered with the end frame in the starter of the embodiment.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### Embodiment

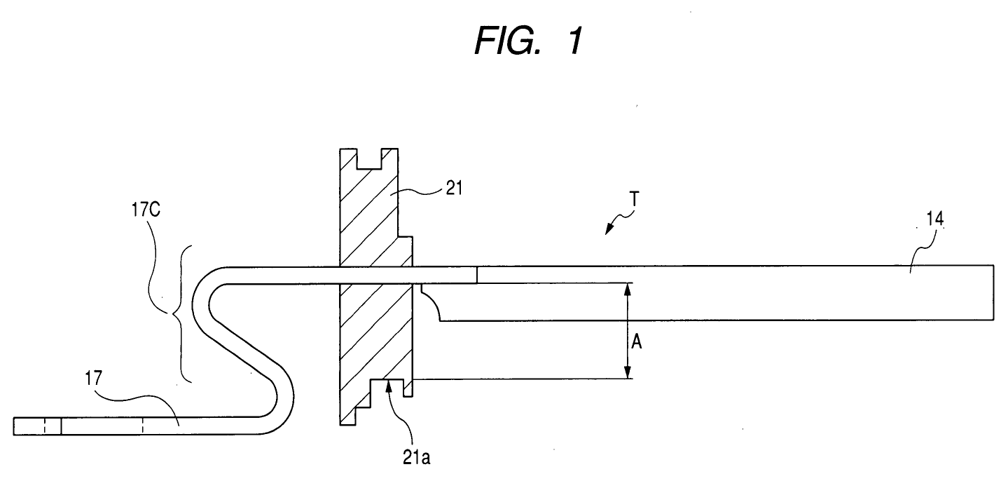

A description will be given of a configuration, functions and effects of a starter 1 according to an embodiment of the present invention with reference to FIG. 1 to FIG. 6.

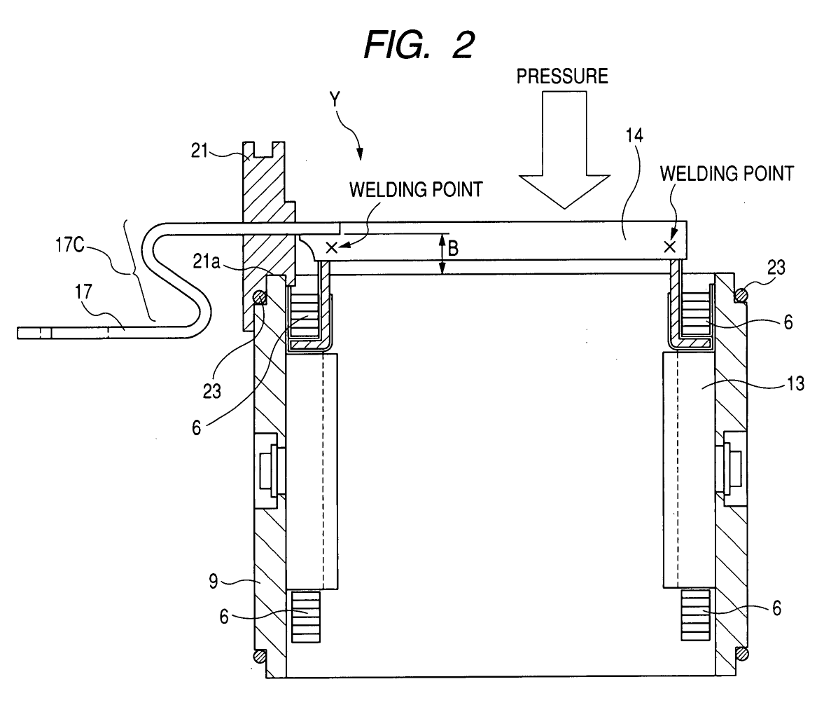

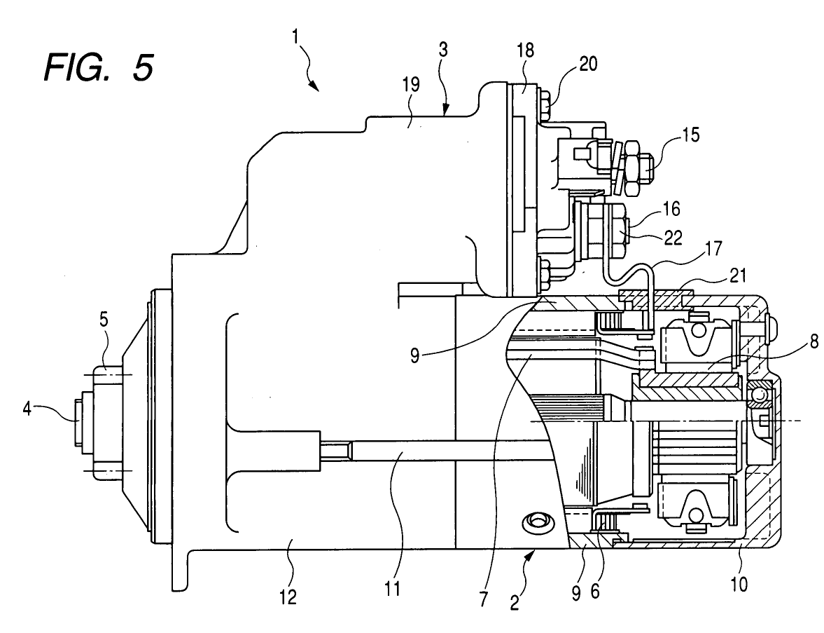

FIG. 1 is a side view of a terminal assembly (ass'y), designated by reference character “T”, in the starter 1 of the embodiment. FIG. 2 is a sectional view of a yoke assembly, designated by reference character “Y”, incorporated in the starter 1 of the embodiment. FIG. 5 is a sectional view showing a part of the starter 1 of the embodiment of the present invention.

As shown in FIG. 5, the starter 1 is composed mainly of an electric motor 2, a magnet switch 3, an output shaft 4, and a pinion 5. The starter 1 cranks an internal combustion engine (omitted from the drawings). The electric motor 2 generates the revolution power. The magnetic switch 3 opens and closes (namely, performs ON/OFF of) a main contact (which will be explained later) of an electric circuit for the electric motor 2. The output shaft 4 rotates driven by the electric motor 2. The pinion 5 is mounted on the output shaft 4.

The electric motor 2 mounted on the starter 1 of the embodiment is a DC (Direct current) series motor in which a field coil 6 and an armature coil 7 are connected in series through a brush 8. In the electric motor 2, an opening part of the yoke 9 forming a magnetic circuit at a rear end side is covered with an end frame 10, and the electric motor 2 and the end frame 10 are tightly fastened to a housing 12 by plural through-bolts 11.

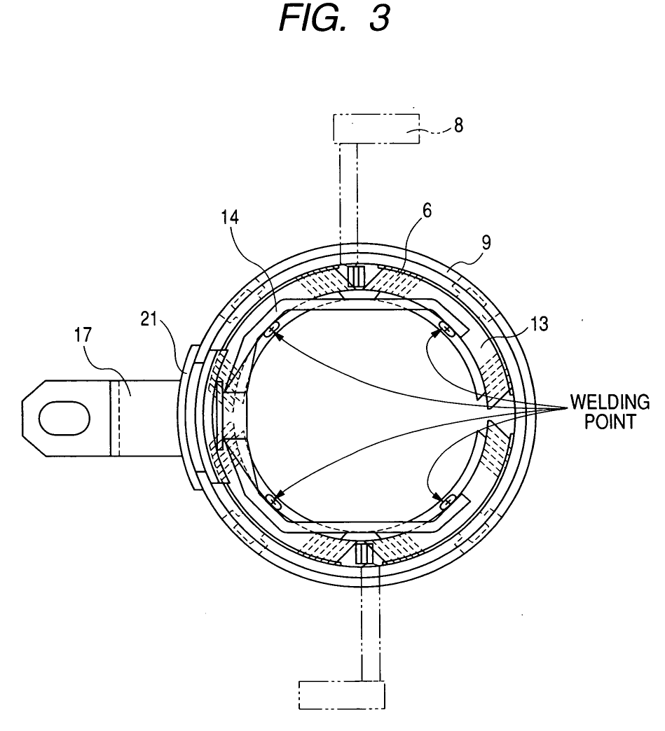

FIG. 3 is a plan view of the yoke assembly designated by reference character “Y” shown in FIG. 2. As shown in FIG. 2 and FIG. 3, the field coil 6 is made of plate shaped conductors wound around the periphery of the field electrode 13 fixed to the inner surface of the yoke 9. One end part of the field coil 6 is electrically connected to a connector bar 14 by welding, for example, and the other end part thereof is electrically connected to a positive electrode of the brush 8. The field coil 6 is not a stranded wire or a twisted wire as a bundle made of plural fine insulated wires, but a plate-shaped conductor having a rigidity characteristic.

The magnetic switch 3 has a magnetic coil (not shown) forming an electromagnet generated on flowing a current therein, and a plunger (not shown) driving the inner side of the magnetic coil. On generating the electromagnet when the current flows therein, the electromagnet attracts the plunger in order to close the main contact. On the contrary, when no current flows through the magnetic coil, the magnetic coil thereby generates no attraction power, the plunger is thereby returned to its original position by a return spring (not shown), and the main contact is thereby open.

The main contact is composed of a pair of stationary contacts (not shown) and a movable contact (not shown). The pair of the stationary contacts are connected to the electric circuit of the motor 2 through a pair of external terminals 15 and 16 (see FIG. 5). The movable contact and the plunger are shifted together. When the pair of the stationary contacts is electrically connected through the movable contact, the main contact becomes closed. On the contrary, when the pair of the stationary contacts is electrically disconnected from the stationary contacts on separating the movable contact, the main contact becomes open.

The external terminals 15 and 16 are a B terminal 15 and a M terminal 16, respectively. The B terminal is electrically connected to a vehicle battery through battery cables (not shown). The M terminal is electrically connected to the motor terminal 17 which is extending from the motor 2. Both of the B terminal and the M terminal are fixed to a contact cover 18 of the magnetic switch 3.

The contact cover 18 is made of resin, for example. As shown in FIG. 5, the contact cover 18 is tightly fastened to a case 19 assembled with the housing 12 by plural bolts 20. The main contact having the above described configuration is placed in the inner space of the contact cover 18.

A description will now be given of the configuration and function of the motor terminal 17.

The motor terminal 17 is supported by and embedded in a grommet 21 that is placed between the yoke 9 and the end frame 10, as shown in FIG. 5. One end part of the motor terminal 17 is extending into the inside of the motor 2, namely, into the inside of the yoke 9 through the grommet 21 and electrically connected to a connector bar 14 by welding as shown in FIG. 1 and FIG. 2. The other end part of the motor terminal 17 is extending into the outside of the motor 2 (namely, into the outside of the yoke 9), and engages with the M terminal 16, and tightly fastened, and fixed to the M terminal 16 by a nut 22 (see FIG. 5).

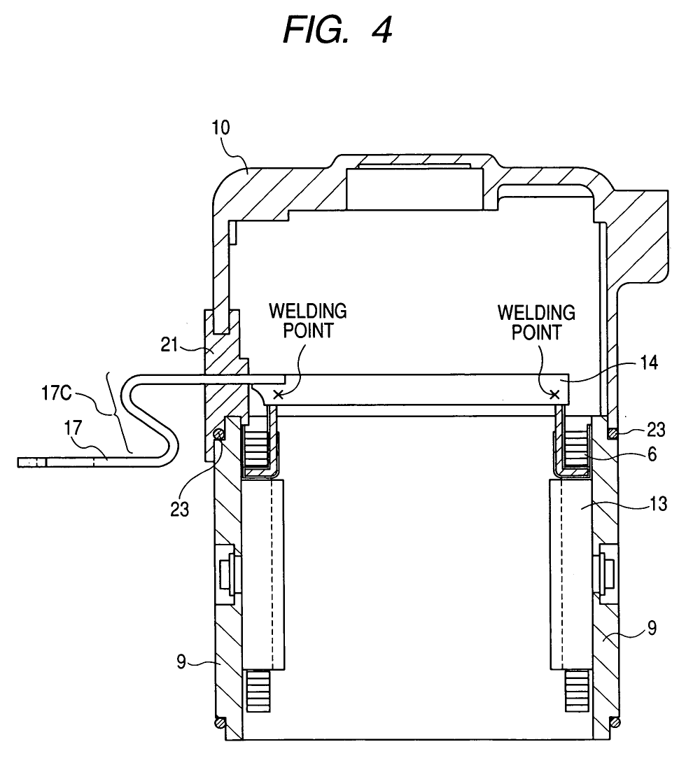

The connector bar 14 is a component through which the motor terminal 17 and the field coil 16 are electrically connected to each other. As clearly shown in FIG. 3, the connector bar 14 has the approximate “C” letter shape obtained by bending copper sheet made of copper. The motor terminal 17 is electrically connected to the connector bar 14 by welding at approximately intermediate point in the longitudinal direction of the connector bar 14 (see FIG. 3). The motor terminal 17 is composed of a plate shaped rigid body made of metal. In the terminal assembly (ass'y) T as shown in FIG. 1, the motor terminal 17 is supported by the grommet 21, and one end part of the motor terminal 17 is connected to the connector bar 14 by welding. The terminal assembly T is composed of the motor terminal 17, the connector bar 14, and the grommet 21. As shown in FIG. 1, FIG. 2, and FIG. 4, the motor terminal 17 extending from the grommet 21 to the outside of the yoke 9 has a curved portion 17c in order to have a resiliency.

Further, as shown in FIG. 2, the terminal assembly T is incorporated into the yoke assembly Y under the condition in which the grommet 21 is attached to the opening part of the yoke 9 and the connector bar 14 and the end part of the field coil 6 are welded to each other. Because the field coil 6 is made of the plate shaped conductor having a rigid characteristic, the connector bar 14 is positioned at the end terminal of the field coil 6 by welding.

The grommet 21 is made of rubber. The motor terminal 17 is electrically insulated with and completely sealed by the grommet 21 from both of the yoke 9 and the end frame 10. An outlet part of the motor terminal 17 is completely sealed with the grommet 21. The grommet 21 is pressed and fastened by the power of the motor terminal 17 toward the yoke 9 side after the yoke assembly Y is constructed. That is, the grommet 21 incorporated into the yoke assembly Y has the following relationship (1):

A>B, (1),

where the variable A (see FIG. 1) designates an interval between a sealing surface 21a of the grommet 21 at the yoke 9 side and the motor terminal 17 in the terminal assembly Y before incorporated in the yoke assembly Y (se FIG. 1), and the variable B (see FIG. 2) denotes an interval between the sealing surface 21a of the grommet 21 at the yoke 9 side and the motor terminal 17 after constructing the yoke assembly Y.

When the connector bar 14 is electrically connected and fixed to the end terminal of the field coil 6 by welding, as shown in FIG. 2, a pressure is applied to the connector bar 14 toward the yoke 9 side so that the pressure is generated at the sealing surface 21a of the grommet 21 at the yoke 9 side from the motor terminal 17 side (namely, the pressure is generated at the area between the sealing surface 21a of the grommet 21 and the motor terminal 17). The grommet 21 is thereby incorporated into the yoke assemble Y through the motor terminal 17 while the motor terminal 17 presses the grommet 21 toward the yoke 9 side. As a result, the grommet 21 is pressed between the sealing surface 21a and the motor terminal 17 toward the yoke 9 side under satisfying the relationship (1) described above.

FIG. 4 is a sectional view showing the yoke assembly Y covered with the end frame 10. After this, as shown in FIG. 4, the grommet 21 is further strongly fastened and completely sealed through O-ring 23 (see FIG. 4) placed at the opening part of the yoke 9 by several through-bolts 11 (see FIG. 5). The grommet 21 is fastened and supported between the yoke 9 and the end frame 10 through the o-ring 23 while the motor terminal 17 presses the grommet 21 to the yoke 9 side.

### (Effect of the Embodiment)

In the starter 1 according to the embodiment of the present invention, the internal between the sealing surface 21a of the grommet 21 and the motor terminal 17 after constructing the yoke assemble Y becomes smaller than that before constructing the yoke assemble Y, namely, in the terminal assembly T, wherein the connector bar 14 is electrically connected and fixed to the end terminal of the field coil 6 by welding when constructing the yoke assembly Y.

That is, the configuration after constructing the yoke assembly Y satisfies the relationship (1) described above. The grommet 21 is thereby pressed and fastened to the opening part of the yoke 9 under the condition where the fastening pressure is applied from the motor terminal 17 to the sealing surface 21a of the grommet 21 at the yoke 9 side on constructing the yoke assembly Y, in other words, while applying the pressure to the sealing surface 21a of the grommet 21 from the motor terminal 17.

Accordingly, the pressure is not applied only to the end frame 10 side, but the pressure is applied to both of the directions, toward the entire of the yoke 9 side and the end frame 10 side through the motor terminal 17 when the opening part of the yoke 9 is covered with the end frame 10 and both of the yoke 9 and the end frame 10 are fastened together by the through bolts 11. That is, because the grommet 21 is fastened and assembled to both the yoke 9 side and the end frame 10 side through the motor terminal 17 while applying the pressure, it is possible to ensure the water proof capability by the grommet 21.

Further, according to the embodiment of the present invention, because the pressure is generated toward the sealing surface 21a of the grommet 21 at the yoke 9 side from the motor terminal 17 side by welding the connector bar 14 to the end part of the field coil 6 in order to perform the positioning of the connector bar 14 and the motor terminal 17, it is not necessary to prepare and use a special jig or fixture, and thereby possible to reduce the number of manufacturing steps and the manufacturing cost of the starter 1.

### MODIFIED EXAMPLE

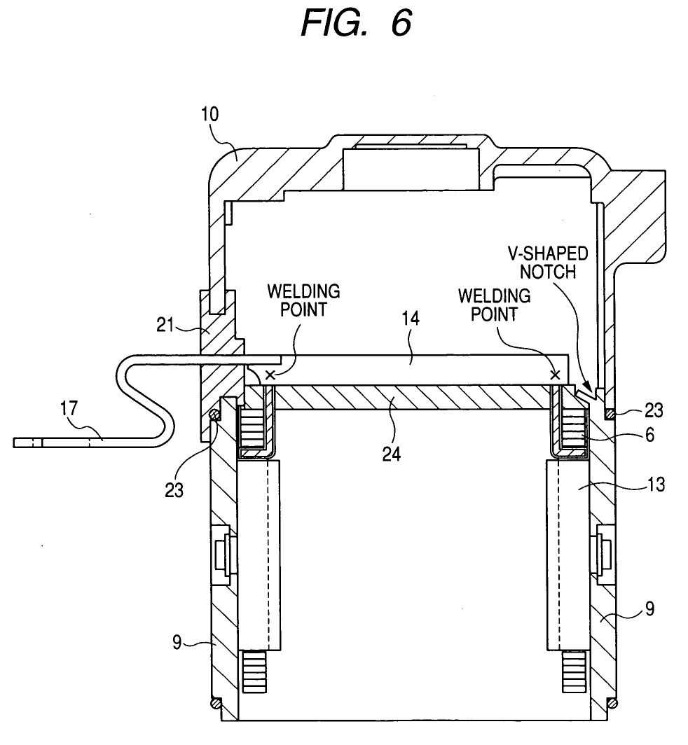

The embodiment of the present invention described above has disclosed the positioning of both the connector bar 14 and the motor terminal 17 by welding the connector bar 14 to the end terminal of the field coil 6. The concept of the present invention is not limited by this. For example, it is acceptable to use an insulator 24 capable of electrically insulating the connector bar 14 from the yoke 9. FIG. 6 shows the insulator 24 incorporated in the yoke assembly Y that is covered with the end frame 10. That is, both of the connector bar 14 and the motor terminal 17 are positioned by the power of the insulator to support the connector bar 14 while satisfying the relationship (1) described above. Because this manner does not require the positioning of the connector bar 14 by welding the connector bar 14 and the field coil 16, it is possible to use a stranded wire or twisted wire as a bundle made of plural fine insulated wires.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A starter comprising:
a yoke forming a magnetic circuit;
an end frame engaging with an opening part of the yoke;
a grommet made of rubber supported between the yoke and the end frame;
a motor terminal composed of a rigid body made of metal that is supported by the grommet;
a field coil arranged in an inner periphery of the yoke; and
a connector bar through which the motor terminal is electrically connected to the field coil,
wherein the grommet is assembled in the starter while the grommet is compressed toward the yoke side from the motor terminal side.

2. The starter according to claim 1, wherein the motor terminal forms a terminal assembly, which is supported by the grommet, and one end part of the motor terminal is electrically connected and fixed to the connector bar, and
the terminal assembly forms a yoke assembly in which the connector bar is electrically connected and fixed to an end part of the field coil, and
the grommet in the yoke assembly has a relationship A>B, where A designates an interval between a sealing surface of the grommet at the yoke side and the motor terminal in the terminal assembly before constructing the yoke assembly, and B denotes an interval between the sealing surface of the grommet at the yoke side and the motor terminal in the yoke assembly.

3. The starter according to claim 2, further comprising an insulator capable of electrically insulating the connector bar from the yoke,
wherein the grommet is pressed toward the yoke side from the motor terminal while the connector bar is supported by the insulator, and
the relationship A>B is satisfied while pressing the sealing surface of the grommet toward the yoke side from the motor terminal.

4. The starter according to claim 2, wherein the field coil is made of a plate shaped conductor having a rigid characteristic wound around field poles fixed to the inner periphery of the yoke, and the grommet is pressed toward the yoke side through the motor terminal while the connector bar is electrically connected and fixed to the end part of the field coil, and the relationship A>B is satisfied so that the sealing surface of the grommet is pressed at the yoke side from the motor terminal.

5. The starter according to claim 1, wherein the motor terminal extending from the grommet to the outside of the yoke has a curved portion in order to have a resiliency.

6. The starter according to claim 2, wherein the motor terminal extending from the grommet to the outside of the yoke has a curved portion in order to have a resiliency.

7. The starter according to claim 3, wherein the motor terminal extending from the grommet to the outside of the yoke has a curved portion in order to have a resiliency.

8. The starter according to claim 1, wherein one end part of the connector bar is electrically connected to the field coil, and the other end part of the connector bar is electrically connected to the motor terminal by welding in the yoke.

9. The starter according to claim 2, wherein one end part of the connector bar is electrically connected to the field coil, and the other end part of the connector bar is electrically connected to the motor terminal by welding in the yoke.

10. The starter according to claim 3, wherein one end part of the connector bar is electrically connected to the field coil, and the other end part of the connector bar is electrically connected to the motor terminal by welding in the yoke.
